(19) United States
(12) Patent Application Publication
(10) Pub. No.: US 2004/0263687 A1
(43) Pub. Date: Dec. 30, 2004

(54) Video signal transmission device, video signal transmission method and video signal reception device

(75) Inventor: Takamichi Muramatsu, Sagamihara-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/803,033

(22) Filed: Mar. 18, 2004

(30) Foreign Application Priority Data
Jun. 30, 2003 (JP) 2003-188702

(51) Int. Cl. H04N 5/46

(52) U.S. Cl. 348/558; 348/556

(57) ABSTRACT

A video signal transmission device comprising a video signal generation unit configured to generate a video signal based on information obtained from a predetermined information source, a signal format judgment unit configured to judge a signal format of the video signal generated by the video signal generation unit, a format information hold unit configured to hold format information indicating a format of the video signal, a signal format conversion unit configured to convert the format of the video signal generated by the video signal generation unit based on the format information held by the format information hold unit and the signal format judged by the signal format judgment unit, and a video signal transmission unit configured to transmit the video signal outputted from the signal format conversion unit.

### CROSS-REFERENCE TO RELATED APPLICATIONS

This application is based upon and claims the benefit of priority from prior Japanese Patent Application No. 2003-188702, filed Jun. 30, 2003, the entire contents of which are incorporated herein by reference.

### BACKGROUND OF THE INVENTION

1. Field of the Invention

The present invention relates to a video signal transmission device and video signal transmission method in which a video signal obtained by receiving broadcasting or reproducing a recording medium is outputted. The present invention also relates to a video signal reception device in which the video signal outputted as described above is inputted.

2. Description of the Related Art

As is well known, for example, a tuner apparatus which receives satellite digital broadcasting and outputs a video signal is connected to a display apparatus including video display units such as a cathode ray tube (CRT), so that the outputted video signal is video-displayed in the display apparatus.

However, when the tuner apparatus is connected to the display apparatus in this manner, a user needs to determine a format of a video signal to be outputted to the display apparatus from the tuner apparatus in consideration of characteristics of both the apparatuses, and this causes a problem that a connecting operation becomes complicated.

In Jpn. Pat. Appln. KOKAI Publication No. 2002-320205, a constitution is described in which the inputted video signal is automatically converted to a signal format for use in a production or transmission system in a broadcasting station from a format of the detected signal, and it is difficult to apply the constitution as it is to versatile apparatuses for general household such as the tuner apparatus and display apparatus.

### BRIEF SUMMARY OF THE INVENTION

According to one aspect of the present invention, there is provided a video signal transmission device comprising: a video signal generation unit configured to generate a video signal based on information obtained from a predetermined information source; a signal format judgment unit configured to judge a signal format of the video signal generated by the video signal generation unit; a format information hold unit configured to hold format information indicating a format of the video signal; a signal format conversion unit configured to convert the format of the video signal generated by the video signal generation unit based on the format information held by the format information hold unit and the signal format judged by the signal format judgment unit; and a video signal transmission unit configured to transmit the video signal outputted from the signal format conversion unit.

According to one aspect of the present invention, there is provided a video signal transmission method comprising: generating a video signal based on information obtained from a predetermined information source; judging a signal format of the generated video signal; holding format information indicating a format of the video signal; converting the format of the generated video signal based on the held format information held and the judged signal format; and transmitting the video signal whose format is converted.

According to one aspect of the present invention, there is provided a video signal reception device comprising: a video signal reception unit configured to receive a video signal; a video signal processing unit configured to subject the video signal received by the video signal reception unit to predetermined signal processing; format information hold unit configured to hold format information indicating a format of the video signal processable by the video signal processing unit; and a format information output unit configured to output the format information held by the format information hold unit.

### BRIEF DESCRIPTION OF THE SEVERAL VIEWS OF THE DRAWING

FIG. 1 is a block diagram showing an outline of a video signal transmission/reception system according to one embodiment of the present invention;

FIG. 2 is a block diagram showing details of a display apparatus in the video signal transmission/reception system;

FIG. 3 is a block diagram showing the details of a tuner apparatus in the video signal transmission/reception system;

FIG. 4 is a flowchart showing a judgment process operation of a video signal judgment unit in the tuner apparatus;

FIG. 5 is an explanatory view of a judgment table to perform a judgment process with respect to a horizontal scanning line number in the video signal judgment unit;

FIG. 6 is a block diagram showing the details of a recording/reproducing apparatus in the video signal transmission/reception system;

FIG. 7 is a block diagram showing another example of the video signal transmission/reception system; and

FIG. 8 is a block diagram showing the details of a reproducing apparatus in the video signal transmission/reception system.

### DETAILED DESCRIPTION OF THE INVENTION

One embodiment of the present invention will hereinafter be described with reference to the drawings in detail. FIG. 1 shows an outline of a video signal transmission/reception system to be described in this embodiment. That is, the video signal transmission/reception system has a constitution in which a tuner apparatus 11 constituting an apparatus on a transmission of a video signal is communicatably connected to a display apparatus 12 constituting an apparatus on a reception of the video signal.

In this constitution, the tuner apparatus 11 has a function of receiving satellite digital broadcastings such as a broadcasting satellite (BS) digital broadcasting and 110-degrees communication satellite (CS) digital broadcasting and transmitting the video signal in a predetermined format to the display apparatus 12 via a satellite antenna 13.

Moreover, the display apparatus 12 has a function of receiving the video signal supplied from the tuner apparatus 11 and displaying video in video display units such as CRT. Furthermore, the display apparatus 12 has a function of notifying information indicating self characteristics, that is, format information indicating the format of a receivable video signal to the tuner apparatus 11.

Moreover, in the tuner apparatus 11, the video signal is automatically converted to a format that can be received by the display apparatus 12 based on the format information notified from the display apparatus 12, and is outputted to the display apparatus 12. Accordingly, a connecting operation of the tuner apparatus 11 to the display apparatus 12 is facilitated, and handling by a user becomes convenient.

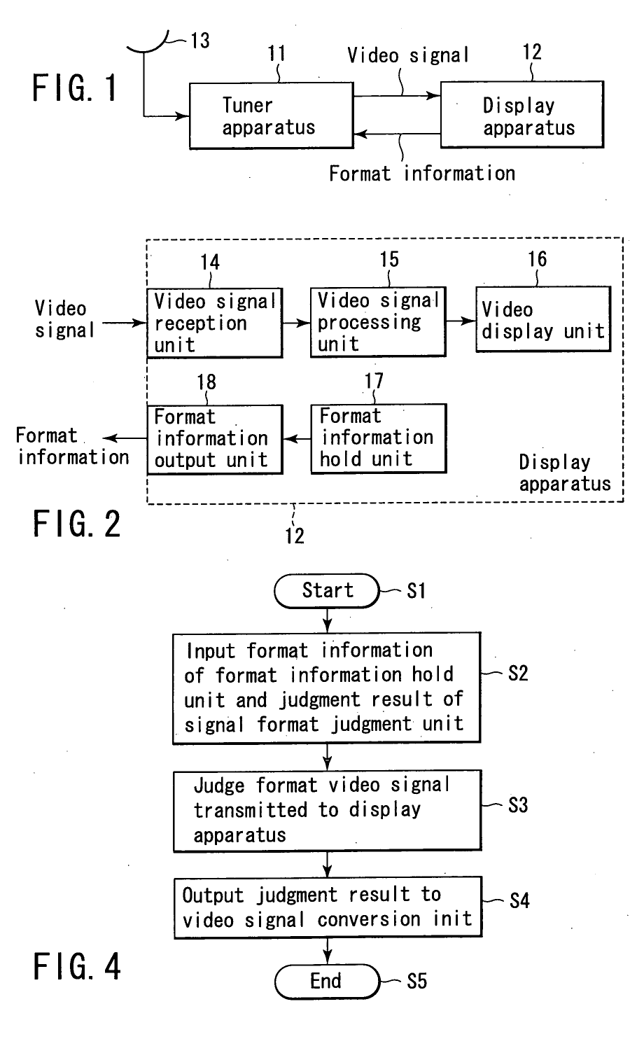

FIG. 2 shows details of the display apparatus 12. The display apparatus 12 receives the video signal transmitted from the tuner apparatus 11 with a video signal reception unit 14. The video signal received by the video signal reception unit 14 is supplied to a video signal processing unit 15 and subjected to predetermined signal processing for video display, and subsequently supplied to a video display unit 16 and video-displayed.

Moreover, the display apparatus 12 includes a format information hold unit 17. The format information hold unit 17 hold the format information indicating the format of the video signal that can be received by the display apparatus 12, that is, that can be processed by the video signal processing unit 15, that is, that can be displayed by the video display unit 16.

The format information includes elements such as an aspect ratio (e.g., 4:3, 16:9 etc.) of a display screen, the number of horizontal scanning lines (e.g., 480, 1080 etc.), and a scanning system (e.g., interlace, progressive etc.).

The format information held by the format information hold unit 17 is outputted to the tuner apparatus 11 via a format information output unit 18. In this case, the format information output unit 18 functions so as to take the format information from the format information hold unit 17 and to output the information to the tuner apparatus 11 in a state in which the format information output unit 18 is connected to the tuner apparatus 11 and communication is established.

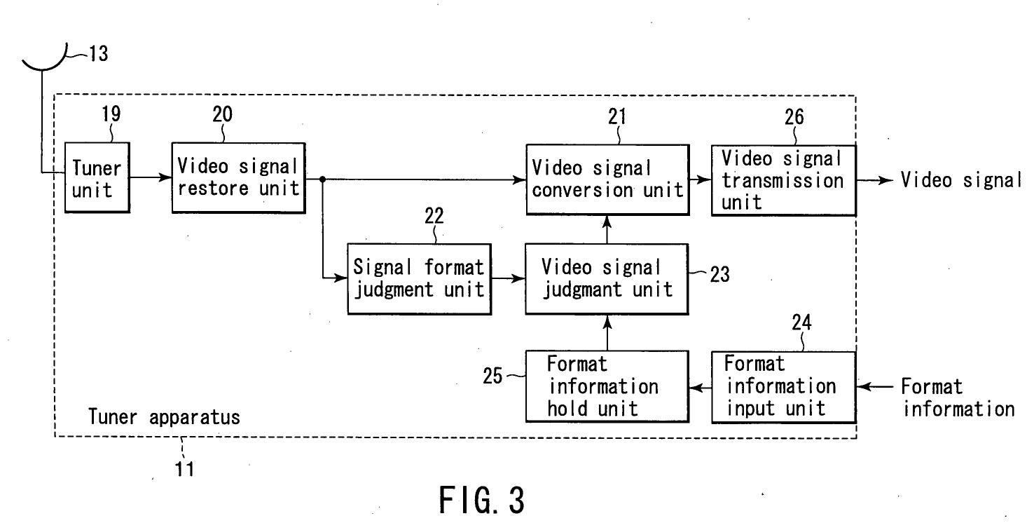

FIG. 3 shows the details of the tuner apparatus 11. The tuner apparatus 11 supplies a digital broadcasting signal received by the satellite antenna 13 to a tuner unit 19. The tuner unit 19 extracts a broadcasting signal of a predetermined channel from the inputted digital broadcasting signal. The broadcasting signal extracted by the tuner unit 19 is supplied to a video signal restore unit 20 and restored into the video signal.

Here, the video signal restored by the video signal restore unit 20 is supplied to a video signal conversion unit 21 and a signal format judgment unit 22. Moreover, the signal format judgment unit 22 judges the format (including the elements such as the aspect ratio, the number of horizontal scanning lines, and the scanning system) from the inputted video signal, and outputs results of the judgment to a video signal judgment unit 23.

Moreover, the tuner apparatus 11 includes a format information input unit 24 which inputs the format information outputted from the display apparatus 12. The format information inputted into the format information input unit 24 is held by a format information hold unit 25. In this case, in the format information hold unit 25, the format information is associated with an identifier of an apparatus to which the format information is outputted, that is, the display apparatus 12 and held.

Furthermore, the video signal judgment unit 23 judges the format of the video signal to be transmitted to the display apparatus 12 based on the format information held in the format information hold unit 25 and the signal format judged by the signal format judgment unit 22, and outputs the judgment results to the video signal conversion unit 21.

For example, when the format information held by the format information hold unit 25 is 480 interlace having an aspect ratio of 4:3, and the judgment result of the signal format judgment unit 22 is 1080i having an aspect ratio of 16:9, the video signal judgment unit 23 judges the video signal having a format of 480i at the aspect ratio of 4:3 is to be transmitted to the display apparatus 12. The judgment result is outputted to the video signal conversion unit 21.

Then, the video signal conversion unit 21 converts the video signal having the format of 1080i at the aspect ratio of 16:9 outputted from the video signal restore unit 20 into the video signal having the format of 480i with the aspect ratio of 4:3. Moreover, the video signal outputted from the video signal conversion unit 21 is outputted to the display apparatus 12 via a video signal transmission unit 26.

FIG. 4 is a flowchart showing a judgment operation of the video signal judgment unit 23. First, when the judgment process is started (step S1), the video signal judgment unit 23 inputs the format information held in the format information hold unit 25 and the judgment result (information indicating the signal format) of the signal format judgment unit 22 in step S2.

Subsequently, the video signal judgment unit 23 judges the format of the video signal to be transmitted to the display apparatus 12 in step S3. This judgment is basically performed so as to convert the format of the video signal outputted from the video signal restore unit 20 into that of the video signal that can be received by the display apparatus 12 in a case where the format of the video signal outputted from the video signal restore unit 20 has a level higher than that of the format of the video signal that can be received by the display apparatus 12, that is, the format of the displayed video.

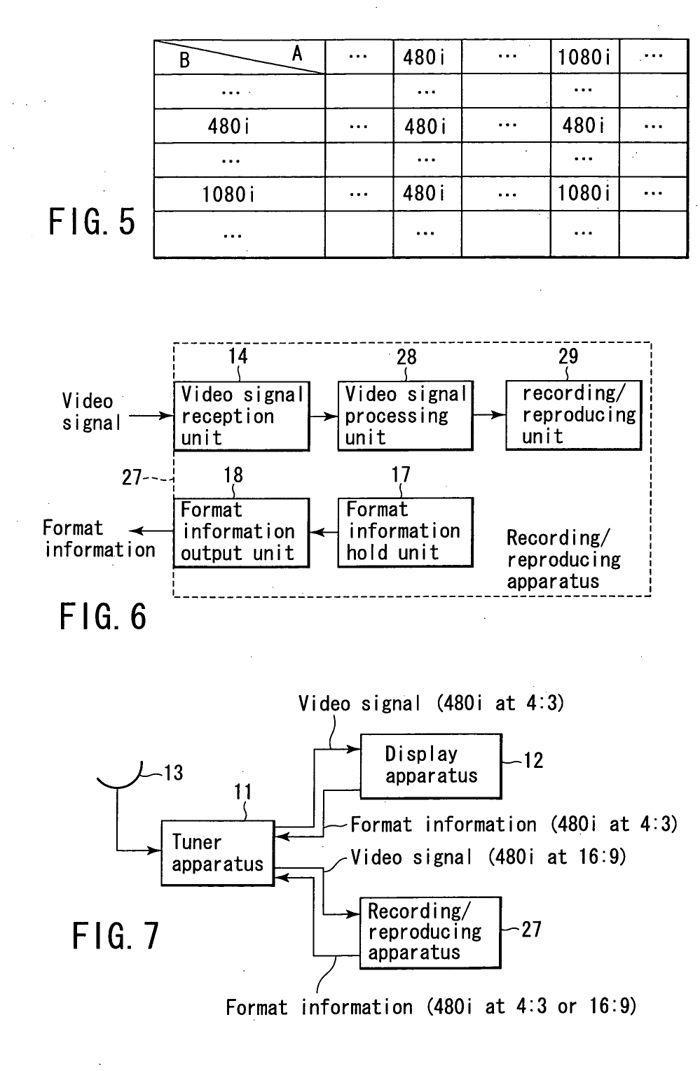

FIG. 5 shows a judgment table disposed so as to perform a judgment process by the video signal judgment unit 23 with respect to the number of horizontal scanning lines. That is, when a judgment result A of the signal format judgment unit 22 is 480i, and even when format information B held in the format information hold unit 25 is either 480i or 1080i, the judgment is made so as to convert the video signal outputted from the video signal restore unit 20 into 480i.

Moreover, when the judgment result A of the signal format judgment unit 22 is 1080i, and the format information B held in the format information hold unit 25 is 480i, the judgment is made so as to convert the video signal outputted from the video signal restore unit 20 into 480i. When the format information B held in the format information hold unit 25 is 1080i, the judgment is made so as to output the video signal of 1080i outputted from the video signal restore unit 20 as it is.

Furthermore, for the aspect ratio, when the judgment result of the signal format judgment unit 22 is 16:9, and the format information held in the format information hold unit 25 is 4:3, the judgment is made so as to convert the aspect ratio of the video signal outputted from the video signal restore unit 20 into 4:3.

Thereafter, the video signal judgment unit 23 outputs the judgment result to the video signal conversion unit 21 in step S4, and here the judgment operation is ended (step S5).

In accordance with the above-described embodiment, the display apparatus 12 notifies the format information indicating the format of the video signal receivable by the display apparatus itself to the tuner apparatus 11, and the tuner apparatus 11 automatically converts the format of the video signal to be transmitted to the display apparatus 12 based on the format information. Therefore, it is not necessary for a user to set the format of the video signal to be outputted to the display apparatus 12 from the tuner apparatus 11, and therefore the handling for the user can be convenient.

Here, in the above-described embodiment, the apparatus which receives the video signal transmitted from the tuner apparatus 11 is assumed to be the display apparatus 12, but, for example, a recording/reproducing apparatus may also be used as the apparatus on the reception of the video signal.

FIG. 6 shows the details of a recording/reproducing apparatus 27 which records/reproduces the information with respect to optical disks such as a digital versatile disk (DVD). In FIG. 6, the same components as those of FIG. 2 are denoted with the same reference numerals, and the apparatus will be described. The video signal transmitted from the tuner apparatus 11 is received by the video signal reception unit 14, subjected to the predetermined signal processing for the recording in a video signal processing unit 28, and subsequently recorded in the optical disk by a recording/reproducing unit 29.

Moreover, in the format information hold unit 17 of the recording/reproducing apparatus 27, the format information indicating the format of the video signal that can be received by the recording/reproducing apparatus 27, that is, that can be processed by the video signal processing unit 28, that is, that can be recorded in the recording/reproducing unit 29 is held.

Furthermore, the format information held in the format information hold unit 17 is taken out of the format information hold unit 17, and outputted to the tuner apparatus 11 via the format information output unit 18 in a state in which the format information output unit 18 is connected to the format information input unit 24 of the tuner apparatus 11 to establish the communication.

Accordingly, the recording/reproducing apparatus 27 notifies the format information indicating the format of the video signal that can be received (recorded) by the apparatus itself to the tuner apparatus 11, and the tuner apparatus 11 automatically converts the format of the video signal to be transmitted to the recording/reproducing apparatus 27 based on the notified format information.

Moreover, as shown in FIG. 7, the tuner apparatus 11 can be connected to both the display apparatus 12 and the recording/reproducing apparatus 27. Furthermore, in this case, the tuner apparatus 11 can transmit the video signals having the formats receivable by the apparatuses to the display apparatus 12 and recording/reproducing apparatus 27.

For example, it is assumed that the format of the video signal outputted from the video signal restore unit 20 of the tuner apparatus 11 is 1080i with an aspect ratio of 16:9, the format of the video signal receivable by the display apparatus 12 is 480i with an aspect ratio of 4:3, and the format of the video signal receivable by the recording/reproducing apparatus 27 is 480i with an aspect ratio of 4:3 or 16:9.

Then, the tuner apparatus 11 operates so as to output the video signal having the format of 480i with the aspect ratio of 4:3 to display apparatus 12 based on the format information obtained from the display apparatus 12 and to output the video signal having the format of 480i with the aspect ratio of 16:9 to recording/reproducing apparatus 27 based on the format information obtained from the recording/reproducing apparatus 27.

Moreover, in the above description, the tuner apparatus 11 is used as the apparatus which transmits the video signal to the display apparatus 12 or the recording/reproducing apparatus 27, but, for example, a reproducing apparatus which reproduces the video signal from a recording medium may also be used as the apparatus on the transmission of the video signal.

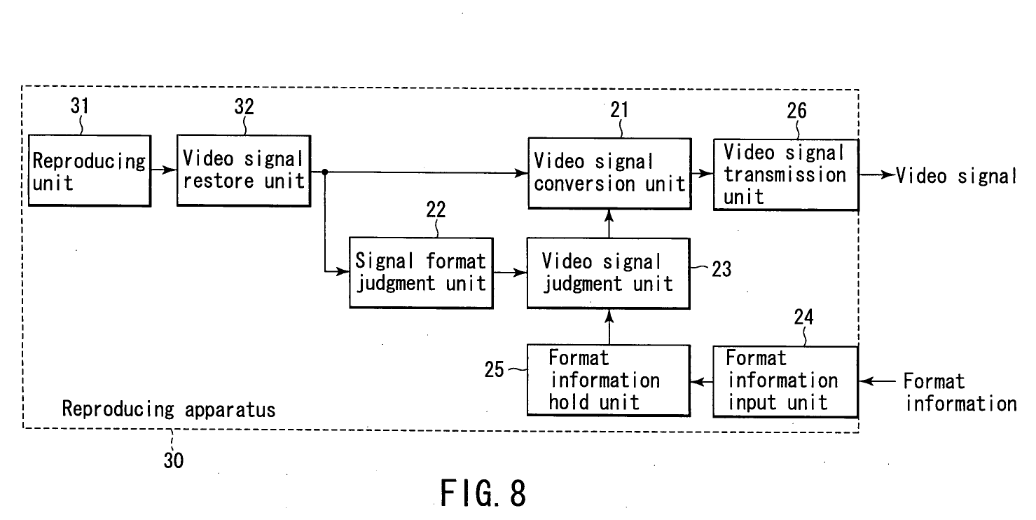

FIG. 8 shows the details of the reproducing apparatus 30 which reproduces the information from the optical disks such as DVD. In FIG. 8, the same components as those of FIG. 3 are denoted with the same reference numerals, and the apparatus will be described. The data obtained by the reproduction from the operates by a reproducing unit 31 is supplied to a video signal restore unit 32 and restored into the video signal. Then, the signal is supplied to the video signal conversion unit 21 and signal format judgment unit 22 in the constitution.

That is, the apparatuses on the transmission of the video signal include an apparatus which receives the broadcasting to obtain the video signal, an apparatus which reproduces the recording medium to obtain the video signal, and an apparatus which obtains the video signal via a network, and a supplier of the video signal is not limited. In other words, the video signal may be generated based on the information obtained from a predetermined information source.

Moreover, the apparatuses on the reception of the video signal include an apparatus which displays the received video signal, an apparatus which records/reproduces the received video signal, an apparatus which transmits the received video signal to another apparatus, and an apparatus which edits/processes the received video signal, and a use mode of the video signal is not limited.

Furthermore, various apparatuses on the transmission of the video signal may be arbitrarily/selectively combined with and connected to various apparatuses on the reception of the video signal to such an extent that mutual mismatch is not caused.

Additionally, to transmit the signal between the apparatus on the transmission of the video signal and the apparatus on the reception of the video signal, various communication means such as cable communication means including IEEE (the Institute of Electrical and Electronics Engineers, Inc.) 1394 and cable local area network (LAN) and radio communication means including wires LAN are usable.

It is to be noted that the present invention is not limited to the above-described embodiment as it is and that constituting elements can variously be modified or embodied without departing from the scope in an implementation stage. Various invention can be formed by an appropriate combination of a plurality of constituting elements described in the above-described embodiment. For example, some constituting elements may also be removed from all the constituting elements described in the embodiment. Furthermore, the constituting elements of different embodiments may also appropriately be combined.

What is claimed is:

1. A video signal transmission device comprising:
a video signal generation unit configured to generate a video signal based on information obtained from a predetermined information source;
a signal format judgment unit configured to judge a signal format of the video signal generated by the video signal generation unit;
a format information hold unit configured to hold format information indicating a format of the video signal;
a signal format conversion unit configured to convert the format of the video signal generated by the video signal generation unit based on the format information held by the format information hold unit and the signal format judged by the signal format judgment unit; and
a video signal transmission unit configured to transmit the video signal outputted from the signal format conversion unit.

2. A video signal transmission device according to claim 1, wherein the signal format conversion unit comprises:
a video signal judgment unit configured to judge the format of the video signal outputted from the video signal transmission unit based on the format information held by the format information hold unit and the signal format judged by the signal format judgment unit; and
a video signal conversion unit configured to convert the format of the video signal generated by the video signal generation unit into the format judged by the video signal judgment unit.

3. A video signal transmission device according to claim 2, wherein the video signal judgment unit makes judgment so as to convert the format of the video signal outputted from the video signal transmission unit to that held by the format information hold unit in a case where the signal format judged by the signal format judgment unit has a video level higher than that of the format held by the format information hold unit.

4. A video signal transmission device according to claim 2, wherein the video signal judgment unit includes an aspect ratio, the number of horizontal scanning lines, or a scanning system as elements by which the format of the video signal outputted from the video signal transmission unit is judged.

5. A video signal transmission device according to claim 1, wherein the video signal generation unit comprises:
a tuner unit configured to extract a broadcasting signal of a predetermined channel from the received broadcasting signal; and
a video signal restore unit configured to generate the video signal from the broadcasting signal extracted from the tuner unit.

6. A video signal transmission device according to claim 1, wherein the video signal generation unit comprises:
a reproducing unit configured to reproduce a recording medium; and
a video signal restore unit configured to generate the video signal from an output of the reproducing unit.

7. A video signal transmission method comprising:
generating a video signal based on information obtained from a predetermined information source;
judging a signal format of the generated video signal;
holding format information indicating a format of the video signal;
converting the format of the generated video signal based on the held format information held and the judged signal format; and
transmitting the video signal whose format is converted.

8. A video signal reception device comprising:
a video signal reception unit configured to receive a video signal;
a video signal processing unit configured to subject the video signal received by the video signal reception unit to predetermined signal processing;
format information hold unit configured to hold format information indicating a format of the video signal processable by the video signal processing unit; and
a format information output unit configured to output the format information held by the format information hold unit.

9. A video signal reception device according to claim 8, wherein the format information held by the format information hold unit includes an aspect ratio, the number of horizontal scanning lines or a scanning system of the video signal processable by the video signal processing unit.

10. A video signal reception device according to claim 8, wherein the video signal processing unit comprises:
a signal processing unit configured to subject the video signal received by the video signal reception unit to signal processing for display; and
a video display unit configured to display the video signal subjected to the signal processing by the signal processing unit.

11. A video signal reception device according to claim 8, wherein the video signal processing unit comprises:
a signal processing unit configured to subject the video signal received by the video signal reception unit to signal processing for recording; and
a recording/reproducing unit configured to record/reproduce the video signal subjected to the signal processing by the signal processing unit.
